(19) United States
(12) Patent Application Publication
(10) Pub. No.: US 2006/0184613 A1
(43) Pub. Date: Aug. 17, 2006

(54) Data conduit

(75) Inventors: David J. Stienessen, Watertown, MN (US); Eric J. Smisek, Faribault, MN (US); Peter A. Thayer, Eden Prairie, MN (US); Jeffrey Ferguson, Prior Lake, MN (US); Margaret L. Ratcliff, Minneapolis, MN (US); Patrick T. Exley, Eagan, MN (US)

Correspondence Address: SHUMAKER & SIEFFERT, P. A., 8425 SEASONS PARKWAY, SUITE 105, ST. PAUL, MN, 55125, US

(73) Assignee: Xata Corporation, Burnsville, MN (US)

(21) Appl. No.: 11/094,854

(22) Filed: Mar. 31, 2005

Related U.S. Application Data
(60) Provisional application No. 60/653,656, filed on Feb. 15, 2005.

(51) Int. Cl. G06F 15/16

(52) U.S. Cl. 709/203

(57) ABSTRACT

This disclosure describes techniques for data transfer between web browsers and a server computer in a web-based environment. In particular, this disclosure describes a data transfer system that includes a set of web-based applications designed to rapidly transfer large amounts of data as a background task, and similarly transfer updated data without requiring a user to request the updated data. In accordance with the invention, a cache of data is stored on the web browser. The web browser and server computer make use of web browser components or add-ins, referred to herein as data conduit modules. The data conduit modules provide the web browsers with the ability to poll the server for updates, as a background task. Additionally, the data conduit modules are capable of retrieving changed data from the server and updating the data in the local cache. Such updates can occur automatically, and independent of user requests.

This application claims the benefit of U.S. Provisional Application Ser. No. 60/653,656, filed Feb. 15, 2005, the entire content of which is incorporated herein by reference.

### TECHNICAL FIELD

The invention relates to a data transfer system and, more particularly, techniques for data transfer between web browsers and a server computer in a web-based environment.

### BACKGROUND

Companies that use software applications for distribution of shared data typically use either a conventional client-server model or a web-based application distribution model for their networks. In the conventional client-server model, a number of terminal computers are attached to a centralized server, and the computers run software that facilitate communication of data from the centralized server to the terminal computers. Due to the extensive architecture required, this conventional client-server model may be expensive to support and maintain. For example, updates to the system may need to be loaded onto every client computer, which is burdensome. For this reason, a number of companies are moving software applications from the conventional client-server model to a web-based application distribution model.

With the web-based model, an application interface is distributed by a web server, and the application interface is able to run on machines, i.e., computers of different hardware types, operating systems, and software versions. In the web-based model, computers are able to view data from the server via a web browser application running on the respective computers. Computers that execute such web browser applications are referred to here as web browsers. When software updates to the system occur at the server, the web browsers typically do not need updated software, as the web browser environment provides flexibility that allows the web browsers to operate somewhat independently of the server applications.

However, one drawback of web-based applications relates to difficulties in receiving data updates of data stored on the server computer, e.g., when such data changes. In particular, when a user is viewing a page, updates to data on the page require the page to be reloaded from the web server. For example, when a user hits the “refresh” button of a web browser, the web browser typically pulls and reloads all the data from the web server, not just the changed data. This may result in a delay as data is transferred before the user can view the updated data.

### SUMMARY

In general, this disclosure describes a system for data transfer between a server and a plurality of web browsers in a web-based environment. More specifically, this disclosure describes techniques for transferring updated data as a background task of a web browser while a user is viewing data on the web browser. The techniques may be particularly advantageous in web-based environments where a large amount of data on the server can be accessed and updated by a plurality of clients. In such cases, the data on the server may change frequently, and require frequent updates to the web browsers.

In accordance with the invention, a cache of data is stored on the web browser. The cache of data may comprise a subset of the data stored on the server, and different clients may store different subsets of the data on the server. The invention makes use of web browser components or add-ins, referred to herein as “data conduit” modules. The data conduit modules provide the web browsers with the ability to poll the server for updates, as a background task. In other words, the data conduit modules can update data on the web browsers without requiring the user to request a refresh of such data. From the perspective of a web user of the web browser, the data conduit modules may have no visibility. The data conduit modules use available memory on the user's computer to cache information associated with the application the user is using.

When a user signs into a web site associated with the server computer, a data conduit module begins retrieving all data that will be pertinent to the user, based on, for example, the user's authenticated task set for the user, and historical operations that the user performed. As the user navigates through various tasks, the data associated with different web pages is filled with data from the cache.

Additionally, the data conduit modules are capable of retrieving changed data from the server and updating the data in the local cache. Again, such updates can occur automatically, and independent of user requests. When data is changed on the web server, for example, by another user also logged in to the website, updated data can be sent to data conduit modules of other users in response to automated requests for updates from data conduit modules of the other users. When the data conduit modules receive new data, they update the local cache and, if the user is currently viewing a screen that uses the data, the data on the screen is also updated by a background process.

Furthermore, the data conduit module of any given user may facilitate data updates from the web browser to the server with respect to any data that the user has changed. In particular, when the user changes data, the data conduit modules send the updates to the web server as a background task.

Moreover, only a narrow stream of data with informational content may be sent between the server and the web browser. Information concerning web page layout, position, and the like is not typically transferred using the data conduit modules. This reduces the amount of communication between the web browsers and the web server, and may greatly reduce communication overhead and increase application speed. Once a local cache of data has been sent from a server computer to a web browser, data updates may include only that data which has changed from the last communication of data from the server computer to the web browser. Time stamps may be maintained at the server computer to facilitate tracking of the updates sent to different web browsers. Time stamping can alternatively be implemented at the different clients to facilitate such tracking.

For transfers of large blocks of data, such as for the initial load of the cache, the data conduit modules may facilitate data compression and decompression. In general, web-based Extensible Markup Language (XML) data is highly compressible, and compression can further reduce the communication overhead between the web server and web browsers, thereby increasing application speed.

In one embodiment, the invention is directed to a method comprising receiving a subset of data at a web browser from a server computer in response to a request from the web browser for the subset of data, the request for the subset of data being a user-initiated event initiated by a user at the web browser, and caching the subset of data at the web browser. The method also includes automatically sending a request from the web browser for updated data, the request for the updated data being a web application-initiated event initiated automatically by the web browser, receiving the updated data at the web browser from the server, and updating the cached subset of data at the web browser to reflect the updated data.

In another embodiment, the invention is directed to a computer-readable medium comprising instructions that when executed by a web browser of a fleet management system cause the web browser to receive fleet management data from a server computer in response to a request from the web browser for the fleet management, the request for the fleet management being a user-initiated event initiated by a user at the web browser; cache the fleet management data at the web browser; automatically send a request from the web browser for updated data, the request for the updated data being a web application-initiated event initiated automatically by the web browser; receive the updated data at the web browser from the server; and update the cached fleet management data at the web browser to reflect the updated data.

In another embodiment, the invention is directed to a method comprising storing a set of data in a database, receiving a request from a first web browser for a first subset of the set of data, the request for the first subset of the set of data being a user-initiated event initiated by a first user at the first web browser, and sending the first subset of the set of data to the first web browser. The method may further comprise receiving a data update from a second web browser, the data update being entered by a second user at the second web browser with respect to a second subset of the set of data, updating the set of data in the database based on the data update received from the second web browser, receiving a request for updated data from the first web browser, the request for the updated data being a web application-initiated event initiated automatically by the first web browser, and sending the updated data to the first web browser in response to the request for the updated data.

In another embodiment, the invention is directed to a computer-readable medium comprising instructions that when executed by a server computer of a fleet management system cause the server computer to store a set of fleet management data in a database; receive a request from a first web browser for a first subset of the set of fleet management data, the request for the first subset of the set of fleet management data being a user-initiated event initiated by a dispatcher at the first web browser; send the first subset of the set of fleet management data to the first web browser; receive a data update from a second web browser, the second web browser being associated with a vehicle of a fleet managed by the fleet management system; update the set of fleet management data in the database based on the data update received from the second web browser; receive a request for updated data from the first web browser, the request for the updated data being a web application-initiated event initiated automatically by the first web browser; and send the updated data to the first web browser in response to the request for the updated data.

In another embodiment, the invention is directed to a device comprising a local cache that stores a subset of data, a user interface application that displays at least some of the subset of data from the local cache, and a data conduit client module. The data conduit client module receives the subset of data from a server computer in response to a request from the data conduit client module for the subset of data, the request for the subset of data being a user-initiated event initiated by a user at the device, stores the subset of data to the local cache, automatically sends a request for updated data, the request for the updated data being a web application-initiated event initiated automatically by the data conduit client module, receives the updated data from the server, and updates the stored subset of data in the local cache to reflect the updated data.

In another embodiment, the invention is directed to a device comprising a central database that stores a set of data, and a data conduit server module that receives a request from a first web browser for a first subset of the set of data, the request for the first subset of the set of data being a user-initiated event initiated by a first user at the first web browser; sends the first subset of the set of data to the first web browser; receives a data update to a second subset of the set of data from a second web browser, the data update being entered by a second user at the second web browser; updates the set of data in the central database based on the data update received from the second web browser; receives a request for updated data from the first web browser, the request for the updated data being a web application-initiated event initiated automatically by the first web browser; and sends the updated data to the first web browser in response to the second request.

In another embodiment, the invention is directed to a system comprising a server that stores and updates a set of data and a plurality of web browsers. Each of the web browsers send data updates to the server to update the set of data, automatically send requests to the server for updates to a subset of the set of data, wherein the automatic requests for updates are web application-initiated events sent by the web browsers, receive data updates from the server in response to the web application-initiated events, and store the data updates to a local cache that contains the subset of the set of data.

The invention may have one or more advantages. For example, the invention may provide the speed of a conventional client-server application with the ease of product support and maintenance of a web-based application. Moreover, the invention may allow for quick and efficient data updates at a plurality of web browsers, whenever shared data on the server computer is changed. By implementing data update requests as an automated background task of the web browser, the need for users to periodically refresh the data can be avoided. This can also ensure that different users are always working with the same shared data. The invention may be particularly useful for environments where a large amount of shared data is maintained on a server computer, but can be changed by many users.

Fleet management systems for managing pickup and delivery by a fleet of vehicles is one environment where the invention may be particularly useful. Commodities trading systems is another such environment where the invention may be particularly useful. In such environments, the actions of one user may affect stored data on the server, which can in turn affect other users. The invention generally provides the ability to maintain accurate subsets of data on different web browser, in an environment involving an ever-changing set of shared data on a server computer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a server and a plurality of web browsers within an exemplary system for implementing a data conduit transfer technique.

FIG. 2 is a block diagram illustrating a plurality of web browsers and a fleet of trucks in communication with a server within an exemplary system for implementing a data conduit transfer technique.

FIG. 3 is a block diagram illustrating an exemplary web browser having a data conduit client module for use in the data conduit transfer technique.

FIG. 4 is a block diagram illustrating an exemplary server computer having a data conduit server module for use in the data conduit transfer technique.

FIG. 5 is a flow diagram illustrating exemplary operation of the data conduit transfer technique from the perspective of a web browser.

FIG. 6 is a flow diagram illustrating exemplary operation of the data conduit transfer technique from the perspective of a server computer.

FIG. 7 is a message flow diagram illustrating the process of initialization in the data conduit transfer technique.

FIG. 8 is a message flow diagram illustrating the process of retrieving data in the data conduit transfer technique.

FIG. 9 is a message flow diagram illustrating the process of updating data in the data conduit transfer technique.

FIG. 10 is a message flow diagram illustrating the process of polling for updated data in the data conduit transfer technique.

FIG. 11 is a message flow diagram illustrating the process of posting an error in the data conduit transfer technique.

### DETAILED DESCRIPTION

In general, this disclosure describes a data transfer system that includes a set of web-based applications designed to rapidly transfer large amounts of data as a background task, and similarly transfer updated data without requiring a user to request the updated data. By way of example, many details of this disclosure are outlined in the context of a fleet management system. Although described in reference to a fleet management system, the invention may find application in environments such as stock exchanges, commodities trading, or any other environment in which many users must access large volumes of shared data that is periodically updated by the different users.

The invention can provide some of the benefits of a conventional client-server model, such as the ability to update and synchronize data quickly, with the ability of a web-based client-server model to easily distribute applications and updates. Moreover, the invention may allow for quick and efficient data updates at a plurality of web browsers, whenever shared data on the server computer is changed. By implementing data update requests as an automated background task of the web browser, the need for users to periodically refresh the data can be avoided. This can also ensure that different users are always working with the same shared data.

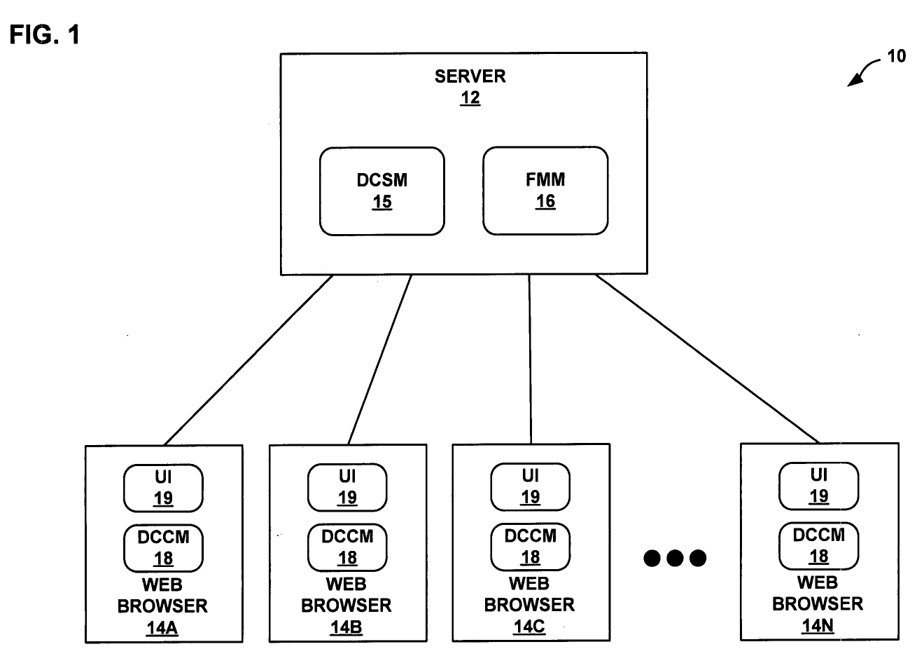

FIG. 1 is a block diagram illustrating a server computer 12 (also referred to as server 12) and a plurality of web browsers 14A-14N (collectively, “web browsers 14”) within an exemplary system 10 implementing a data conduit transfer technique. Web browsers 14 are generally computers that execute web-based browsing applications consistent with web-based models of communication. System 10 is a data transfer system with the ability to quickly transfer a large amount of data from server 12 to web browsers 14 as a background task on web browsers 14. In the example of FIG. 1, server 12 is a computer that has a data conduit server module (DCSM) 15 and a fleet management module (FMM) 16.

Web browsers 14 may comprise any type of computer platform such as desktop computers, workstations, laptop computers, portable computers, or any other computer platform. Web browsers 14 executed web browsing applications to facilitate user access to data on server 12. Web browsers 14 are communicatively coupled to server 12, e.g., via a physical transmission line or wireless channel. In some cases, communications between server 12 and web browsers 14 may pass through a number of other computers, such as routers or switches commonly used in packet-based communication environment. Each of web browsers 14A-14N has a user interface (UI) application 19 and a data conduit client module (DCCM) 18. UI application 19 may be standard a web browser application such as Internet Explorer, Netscape Navigator, Opera, Mozilla Firefox, or any similar browser application. DCCM 18 may be a component or add-in of UI application 19.

A user (not shown) of web browser 14A, such as a dispatcher in a fleet management system, can use UI interface 19 to access data from server 12 via DCCM 18. Generally, upon the user's startup of the UI application 19, DCCM 18 calls DCSM 15 of server 12 to request data. Server 12 stores a set of data in a central database (not shown). DCCM 18 will request a particular subset of the set of data that the user will need. The subset of data associated with a given web browser may be based upon a user's authenticated task set, and historical operations performed by the user, which may be included in the request for data from the web browser.

Server 12 receives the request via DCSM 15. DCSM 15 calls FMM 16 to retrieve the requested data. FMM 16 accesses the subset of data from the central database within server 12. As will be discussed in further detail below, DCSM sends the requested subset of data. DCCM 18 receives the subset of data and saves it to a cache, e.g., a local cache (not shown), on the web browser 14. The user may then access any of the subset of data from the local cache via UI application 19. In particular, as the user navigates through his tasks, the data on each web page is filled with data from the local cache.

If the user makes an update to the subset of data in the local cache of web browser 14A, DCCM 18 will access the updated portion of the subset of data and send it to server 12. In addition, DCCM 18 will periodically poll server 12 for updates to the set of data in the central database of server 12. The polling frequency of each of clients 14 may be configurable. Updated data on the central database of server 12 may result from other users posting updated data to server 12 from other web browsers, or possibly a change by an administrator at server 12.

DCCM 18 of web browser 14A polls server 12 as a background task that is independent from and invisible to the user. In this sense, the polling for data updates is a web-application initiated event imitated automatically by web browser 14A and not the user. On server 12, DCSM 15 receives the request for updated data and checks to see whether any data has been updated by calling FMM 16. If FMM 16 finds an update, DCSM 15 sends the updated data to DCCM 18, which saves the updated data in the local cache on the web browser. If the user is currently viewing a web page that uses the updated data, the data on the web page is also updated.

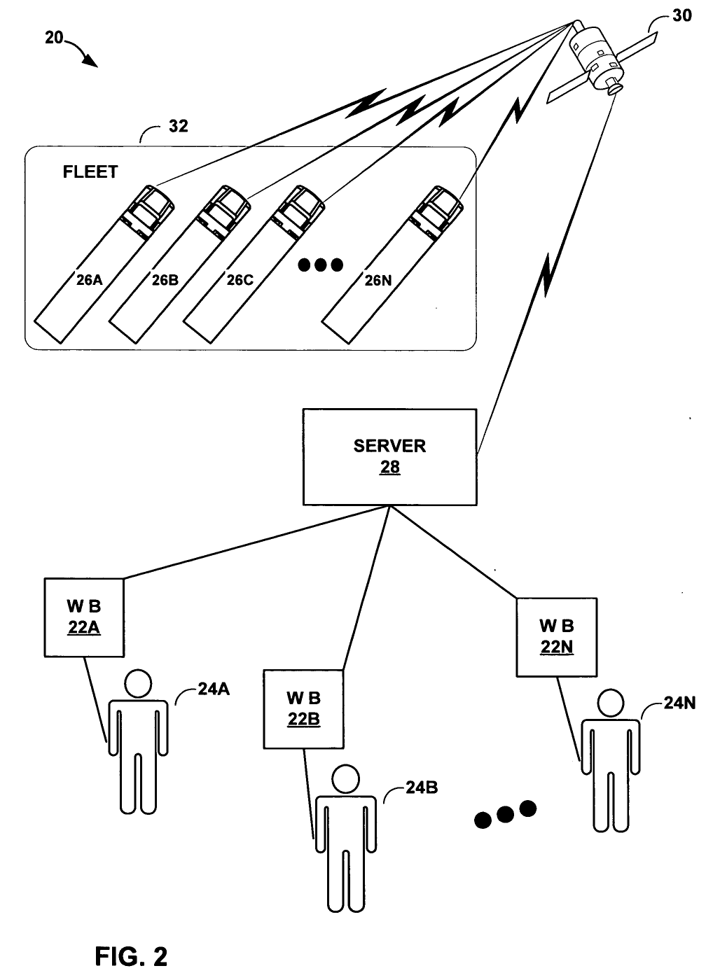

FIG. 2 is a block diagram illustrating a plurality of web browsers (WB's) 22A-22N and a fleet 32 of trucks 26A-26N in communication with a server 28 within an exemplary system 20 for implementing a data conduit transfer technique. A plurality of trucks 26A-26N comprises fleet 32. Although shown for purposes of example with a single fleet 32, system 20 may have a number of other fleets in addition to fleet 32. Web browsers 22A-22N are generally computers that execute one or more web-based browsing applications consistent with web-based models of communication described herein.

The drivers (not shown) of trucks 26A-26N may communicate data to server 28 by way of onboard computers. In addition, it may be possible that some information about the trucks, such as gas mileage or truck diagnostic information, may be sent automatically by such onboard computers. The onboard computers may communicate with server 28 through a satellite communication, e.g., via satellite 30, or via a terrestrial wireless communication system such as a packet-based network, or possibly a cellular-based network similar to those used for cellular radiotelephone communication. The onboard computers may also monitor variables associated with trucks 26A-26N, such as odometer readings, gas mileage or usage, oil pressure or other parameters that can identify possible malfunction or failure, cargo load, or any other variable associated with trucks 26A-26N.

Dispatchers 24A-24N (collectively, “dispatchers 24”) are users of web browsers 22A-22N (collectively, “web browsers 22”), respectively. Dispatchers 24A-24N may manage a fleet of trucks such as fleet 32, using a subset of the fleet management data stored in server 28. In particular, each dispatcher may be assigned a subset of trucks in the fleet, and can select and manage routes for the trucks. In some cases, different trucks may be assigned to two or more users. In any case, the actions of different users can affect the set of data on server computer 28, and therefore affect the other subsets of data seen by other users. The invention provides for data management to ensure that any given user is always making decisions based on accurate and up-to-date data.

Fleet management data may include information sent by truck drivers and trucks 26A-26N to server 28. By way of example, the fleet management data may contain trucks information, driver information, trip/delivery information, and sites information. Trucks information may include information regarding the current location of each truck, information regarding the cargo of each truck, fuel information indicative of how much fuel each truck has available, information regarding the size and/or hauling capacity of the truck, or other information related to a given truck.

Driver information may include information such as how many hours the truck driver can legally drive based on United States Department of Transportation regulations, the rating of the driver (i.e., what he or she can haul), information regarding driver qualification, hourly quotas, age, past performance and reliability, or other information relating to a given driver. Trip/delivery information may include specific information relating to scheduled deliveries, priority information indicating priority or time-sensitive delivery, information indicative of scheduled deliveries, or any changes thereof. Sites information may include pick-up information regarding loads that need to be picked up by a driver, information relating to locations of sites, and site-specific requirements for deliveries.

Dispatchers 24 may use this fleet management data to present a desirable schedule for the driver that will, for example, minimize fuel use, minimize drive time and wear and tear to the truck, and maximize the load the driver can deliver. In order to create efficient schedules, each of dispatchers 24 requires quick access to a large amount of data. Moreover, this data may change periodically, whenever a driver or dispatcher sends new data to the server. For example, one of dispatchers 24 may make a change in data that is sent to server 28, and this may affect decisions by other dispatchers. In general, dispatchers 24 must be made aware of the changed data as quickly as possible so that they are working with current data.

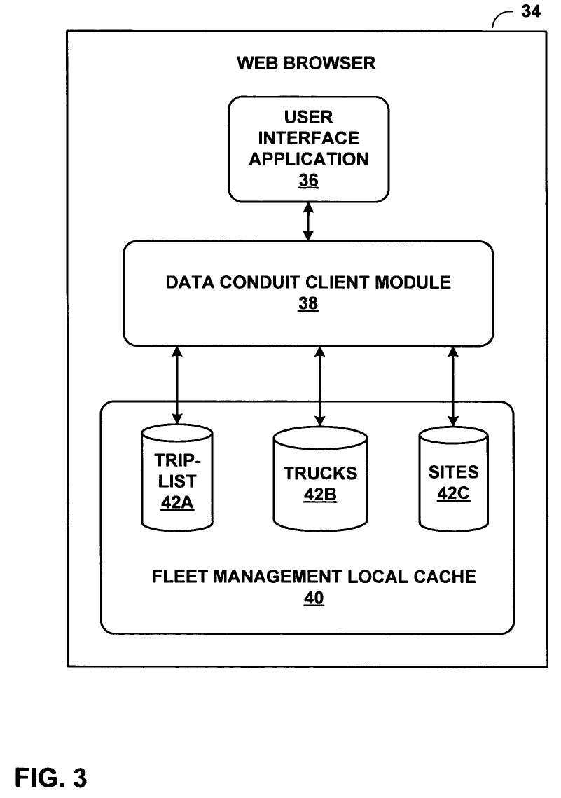

FIG. 3 is a block diagram illustrating an exemplary web browser 34 having a data conduit client module 38 for use in the data conduit transfer technique. Web browser 34 may correspond to web browser 22A of FIG. 2, accessed by a user such as dispatcher 24A. Web browser 34 is generally any computing device that executes one or more web-based browsing applications consistent with web-based models of communication described herein.

Web browser 34 has a user interface application 36, e.g., a conventional web browser application platform. Dispatcher 24A may use user interface application 36 to access fleet management data from fleet management local cache 40. Fleet management local cache 40 contains a subset of data that dispatcher 24A may need to access in performing fleet management tasks. Fleet management local cache 40 may contain data subsets such as TripList data 42A, Trucks data 42B, and Sites data 42C (collectively, “subsets of data 42”). Fleet management local cache 40 may contain other subsets of data in addition to those shown. Subsets of data 42 are generally subsets of the set of fleet management data found on the server.

In order to provide dispatcher 24A with fast access to updated data, web browser 34 has a data conduit client module (DCCM) 34. As dispatcher 24A navigates through tasks on UI application 36, DCCM 34 fills the web pages with data from fleet management local cache 40.

In general, when DCCM 38 polls server 28 for updated data, it asks for any data that has changed since the last time it polled. This call to the server 28 may include a last poll time indication of the last time web browser 34 polled server 28 for updated data. Server 28 uses the last poll time indication to decide what updated data to send to web browser 34. When data is updated on server 28, e.g., a truck 26 or another dispatcher 24 adds, edits, or deletes a record, the record on server 28 is marked with a time stamp. After server 28 receives a request for updated data, it sends to the client any data with a time stamp more recent than the last poll time, indicated in the request.

In the case of an initial request for a subset of data where there were no earlier polls, DCCM 38 will include a last poll time indication indicating this, such as with a last poll time indication of “zero.” When server 28 receives a request for updates with a last poll time indication of “zero,” server 28 will send all the data for the data subsets requested, since all the data will have a time stamp more recent than “zero.”

In the future, when web browser 34 is polling for data updates, server 28 will send all data with records more recent than the last poll time, if any. DCCM 38 then changes its “last poll time” to the current time. In alternative embodiments, the last poll time of each web browser may be stored at server 28, and may be referenced by server 28 when a web browser makes a request for updates.

When dispatcher 24A first starts up UI application 36, UI application 36 calls DCCM 38 to initiate the data conduit program. DCCM 38 calls server 28 with a request for a subset of data. DCCM 38 requests the particular subset of data the user will need. Different users may have different authorization levels, and so different initial subsets of data may be retrieved from server 28 depending on the user. The data that is sent to a given client may be determined based on the user's authenticated task set and historical operations performed by the user. DCCM 38 receives the subset of data from server 28 and saves it to fleet management local cache 40. Dispatcher 24A may then access any of the data from fleet management local cache 40 via UI application 36.

DCCM 38 may be configured to periodically poll server 28 for updates to the data subsets found in fleet management local cache 40, for example, every 5 minutes. The polling frequency may be defined or possibly changed, and possibly defined differently for different data types. This polling for updates is an automatic request, initiated by DCCM 38 acting on web browser 34. The requests for updates may occur as a background task on web browser 34, while dispatcher 24A is using UI application 36 to perform fleet management tasks. In other words, the request for updates are web application-initiated events initiated automatically by the web browser.

In the situation where DCCM 38 polls for updates, DCCM 38 sends a request to server 28 for any data updated since the last time it polled, and receives the updated data from server 28. The received updated data may be in the form of an extensible markup language (XML)-based Simplified Object Access Protocol (SOAP) message. If the updated data is large, server 28 may have compressed it before sending, in order to increase data transfer speed. In this case, DCCM 38 de-compresses the data. In any case, DCCM 38 extracts the data from the attachment and updates the subsets of data 42 stored in fleet management local cache 40 in accordance with the received updated data.

In one embodiment, DCCM 38 may use port 80 or port 8080 of web browser 34 to communicate with server 28. Port 80 is a standard open port for web browsers, i.e., the default browser port, which facilitates implementation with differing corporate firewall configurations such as Hypertext Transfer Protocol (HTTP). The invention is particularly useful in such environments where the server cannot send information unless and until a given web browser makes a request for such information. In this case, it can be challenging to deliver data updates to the web browser of shared information stored on the server. The invention implements the data conduit techniques as automated background tasks so that requests for data updates are automatically sent, which can provide better server-side control of the information viewed at the different web browsers, and essentially make such data updates appear to be server-driven even thought web browser requests for such updates are needed.

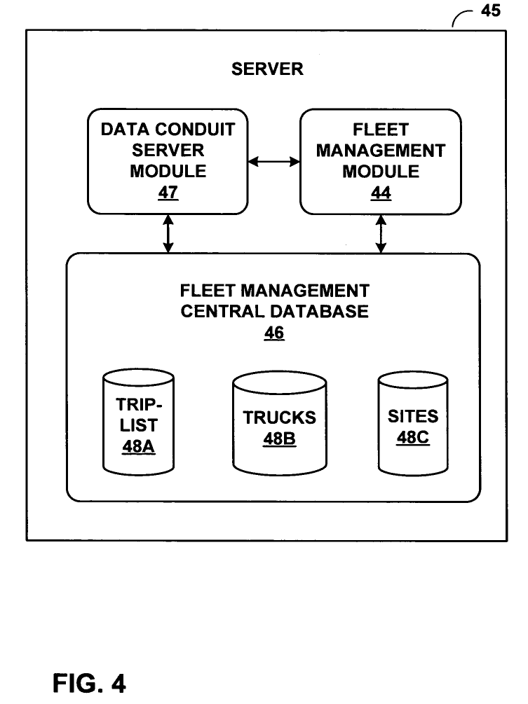

FIG. 4 is a block diagram illustrating an exemplary server computer 45 (also referred to as server 45) having a data conduit server module (DCSM) 47 and a fleet management module (FMM) 44 for use in the data conduit transfer technique. Server 45 also has a fleet management central database 46, having data sets such as TripList data 48A, Trucks data 48B, and Sites data 48C (collectively, “central data sets 48”). Server 45 may correspond to server 28 of FIG. 2, and may receive data from fleet 32 and dispatchers 24. Server 45 may also receive requests for data sets or be polled for data updates by web browsers such as web browsers 22 or web browser 34 (FIG. 3).

When web browser 34 sends an initial request for data to server 45, server 45 receives the request via DCSM 47. DCSM 47 calls FMM 44 to retrieve the requested data. FMM 16 accesses the data from a central database (not shown) within server 12. On an initial call DCCM 38 gives a last poll time indication of “zero,” and so FMM 44 will select all the data for the data sets requested, because all data has a time stamp more recent than the last poll time.

FMM 44 gives the requested data to DCSM 47. For large blocks of data, such as the initial load to fill the fleet management local cache 40, DSCM 42 may compress the data using a data compression algorithm. This compression may further reduce the communication overhead in the data conduit transfer technique, increasing application speed. Compression may be used for all information that is sent, but is particularly effective when large blocks of data are sent.

DCSM 47 will then format the data as an XML document and send the requested data to web browser 34 as an attachment to an XML-based SOAP message. Adding it as an attachment to the SOAP message may allow for a faster download to the client since it bypasses the encoding that would be needed to put it in the SOAP message body. To add the attachment, DCSM 47 may use a service such as Microsoft's Web Service Enhancements 2.0.

In addition, server 45 may receive a data update from a user. For example, a dispatcher 24 or a truck 26 may add, edit, or delete data of a data set. DCSM 47 receives a call from the user's DCCM requesting that the data be modified. DCSM 47 passes the data to FMM 44 to update the fleet management central database 46. In the case where two users attempt to modify the same data, FMM 44 will choose one of the modifications, for example, the modification received first, and return an error message to the sender of the other modification. DCSM 47 sends a status message to the users. The user whose modification is made is notified that the modification was successful. The updated data is displayed on the user's web browser by the UI application. The user whose modification is not made will be notified that their data update failed, and the user may try again later.

Server 45 may also receive automatic polling requests from web browser 34, which asks for any data that has changed since the last time it polled. FMM 44 will retrieve all data with time stamps more recent than the last poll time indicated in the web browser's request. FMM 44 packages the updates as an XML document and creates a SOAP attachment. FMM 44 may also add an additional “action” attribute for each node in the XML. The action attribute may contain an ‘A’ for add, ‘E’ for edit, or ‘D’ for delete. Finally, DCSM 47 sends the updates to web browser 34 as an attachment to a SOAP message.

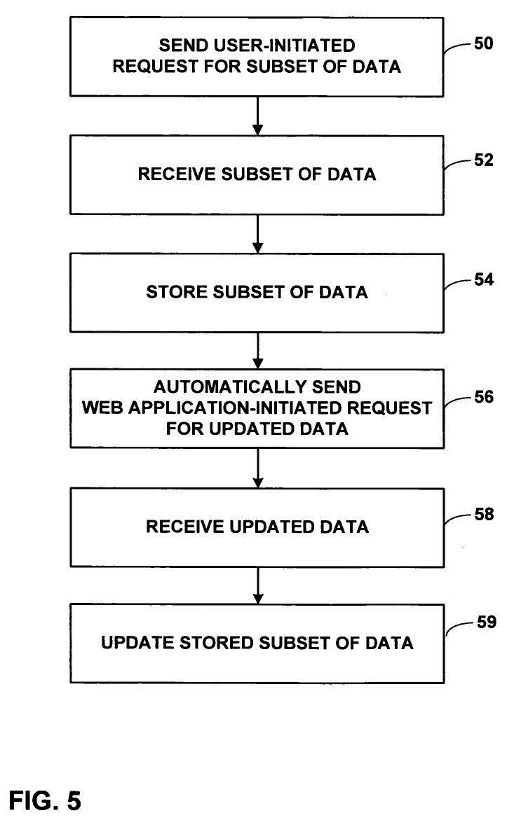

FIG. 5 is a flow diagram illustrating exemplary operation of the data conduit transfer technique from the perspective of a web browser, such as web browser 34 of FIG. 3. A user of web browser 34 may start up the UI application 36, e.g., a web browser. In response, DCCM 38 sends a request to server 45 for a subset of data to fill the fleet management local cache 40 (50). This request is a user-initiated event in the sense that the user initiates the request by initiating start-up of the web browser. Upon receiving the requested data (52), DCCM 38 stores the subset of data to fleet management local cache 40 (54). This subset of data is now available for viewing by the user with the web browser.

The subset of data is passed by DCCM 38 to UI application 36 for display on the web browser. If the user is currently viewing a portion of the subset of data on a webpage on the web browser, UI application 36 may update this currently active data on the webpage while it is being viewed. In some embodiments, DCCM 38 may prioritize an order of updating data, updating the currently active set of the subset of data prior to updating a currently inactive set of the subset of data.

Web browser 34 may be configured to automatically poll server 45 for updated data to ensure that the user will have accurate data with which to perform his fleet management tasks. In doing this, DCCM 38 automatically sends a web-application initiated request to server 45 for any data updated since the last time web browser 34 polled the server (56). This request is a web application-initiated event in the sense that it takes place as a background task on the computer, and is performed automatically without being initiated by the user in any way. Upon receiving the updated data (58), DCCM 38 updates fleet management local cache 40 to reflect the received updated data (59).

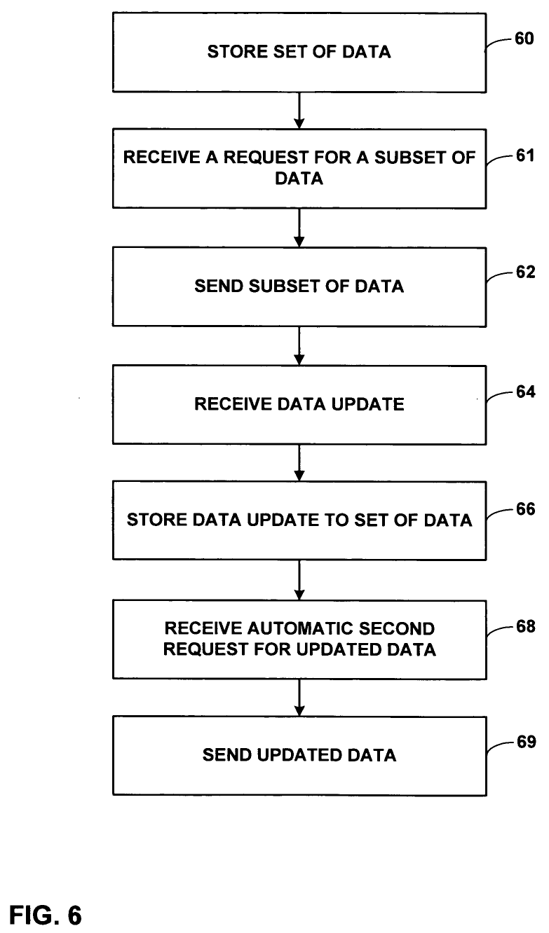

FIG. 6 is a flow diagram illustrating exemplary operation of the data conduit transfer technique from the perspective of a server computer, such as server 45 of FIG. 4. Server 45 stores a set of data in a database such as fleet management central database 46 (60). Server 45 may receive a request for a subset of data from a web browser such as web browser 34 (61). Specifically, the request is received by DCSM 47 and forwarded to FMM 44. FMM 44 accesses the subset of data from the fleet management central database 46, compresses the subset of data if necessary, and packages it as an attachment to an XML-based SOAP message as described above. This goes to DCSM 47, which sends the subset of data to web browser 34 (62).

After sending the subset of data to web browser 34, server 45 may also receive a data update from another web browser that may add, edit, or delete a portion of its own subset of data (64). DCSM 47 receives the data update and passes the data to FMM 44 to store the updated data to the fleet management central database 46 (66). A time stamp may be saved with the updated data on server 45 to indicate when it was updated.

Server 45 may then receive a polling request for updates from web browser 34 (68), asking for any data updated since the last time web browser 34 received data. This request may include a last poll time indication. DCSM 47 receives the request, passes it to FMM 44 which retrieves the updated data from fleet management central database 46 based on a comparison of the last poll time indication to the time stamps on the data.

FMM 44 again compresses the data update if necessary, and packages it as an attachment to an XML-based SOAP message as described above. This goes to DCSM 47, which sends the data to web browser 34 (69).

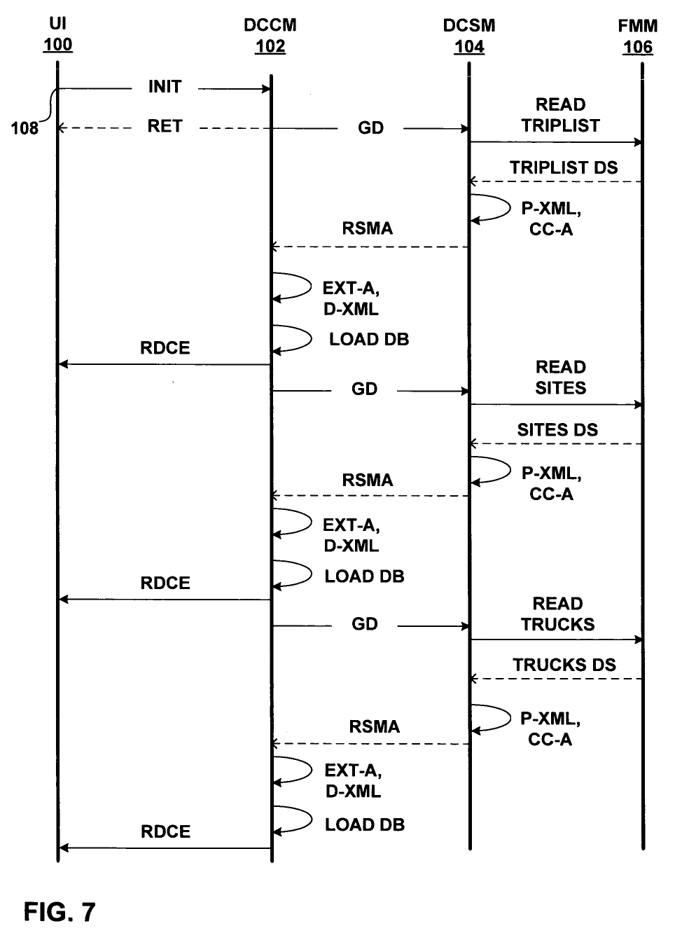

FIG. 7 is a message flow diagram illustrating the process of initialization in the data conduit transfer technique. The diagram illustrates the interaction of user interface (UI) application 100, data conduit client module (DCCM) 102, both of which reside on a web browser, and data conduit server module (DCSM) 104 and fleet management module 106, both of which reside on a server computer.

The process of initialization starts at the web browser, when a user starts the user interface application (108). Upon startup, the UI application 100 calls an Initiate method (INIT) on DCCM 102. DCCM sends an immediate return (RET) message back to UI 100. DCCM 102 then calls the Get Data (GD) method of the DCSM 104 for each of the data sets the user is authorized to view (e.g., Trips, Trucks, and Sites data sets). From this point on, the process outlined below is repeated for each of the data sets requested.

When DCCM 102 calls to get data from DSCM 104, it includes a last poll time indication of “zero” for this initialization call. Since the last poll time indication shows “zero” for the last poll time, DSCM 104 will send all the data for the data sets requested.

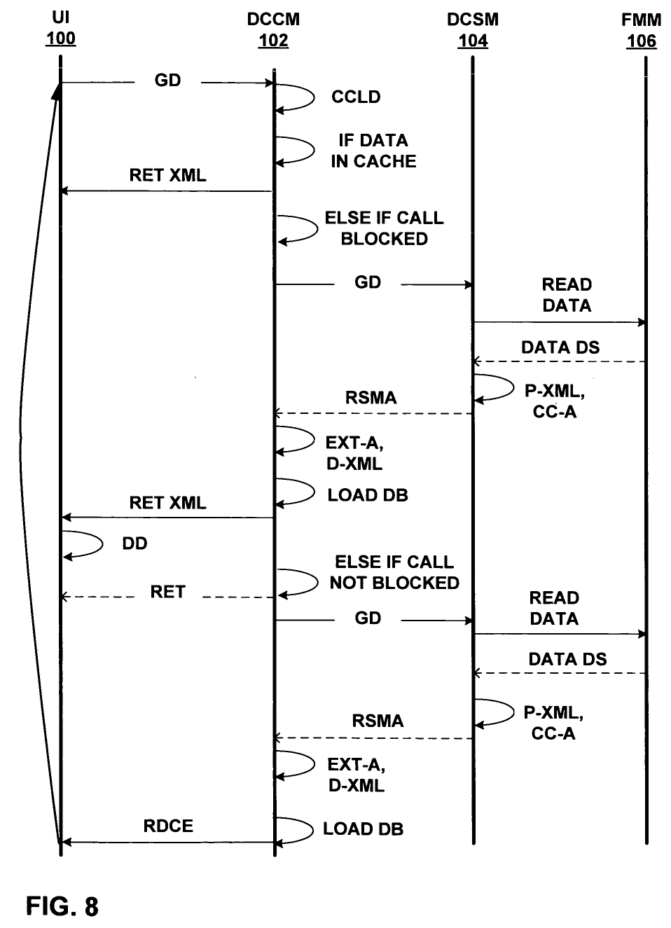

The first GD call shown in FIG. 8 is for the TripList data set (TripList DS). Upon receiving the GD call from DCCM 102, DCSM 104 calls fleet management module (FMM) 106 to retrieve the requested data set from the fleet management central database. FMM 106 sends the TripList data set to DCSM 104. DCSM 104 packages the data set, for example, as an extensible markup language (XML) file, an action indicated by “P-XML” on FIG. 8, and compresses the data and creates a SOAP attachment, indicated by “CC-A.” DCSM 104 returns the SOAP message with attachment (RSMA) to DCCM 102 on the web browser.

DCCM 102 extracts the attachment and decompresses the XML file (EXT-A, D-XML), and loads the XML to the local cache (LOAD DB). DCCM 102 also raises a “data changed” event (RDCE) to UI application 100 that the returned data is available. UI application 100 can then retrieve the data it is interested in by calling the Get Data method on DCCM 102. If DCCM 102 has not yet retrieved the data from DCSM 104, an empty XML document will be returned in response to a request for such data. The process of raising data changed events indicates that the updated information is available, may be repeated for the Sites data set (Sites DS) and the Trucks data set (Trucks DS) any time such data is changed.

FIG. 8 is a message flow diagram illustrating the process of retrieving a subset of data in the data conduit transfer technique. Such a process may take place when, for example, a user of a web browser accesses a web page. The web page may display a subset of a set of data found in the web browser's local cache or in a server's central database. To retrieve the subset of data, UI application 100 calls the get data (GD) method on DCCM 102. This occurs as a background task on the web browser. DCCM 102 will check for the requested subset of data in the web browser's local cache (CCLD). If the subset of data is in the local cache, it will be returned to UI application 100 immediately (RET XML).

If the subset of data is not in the local cache, DCCM 102 will check the status of the blocking parameter passed on in the GD call. If the blocking parameter is set, i.e., the call is blocked, DCCM 102 will call DCSM 104 with a GD request. The server components DCSM 104 and FMM 106 then go through a process of retrieving the subset of data from the central database similar to the initialization process. DCSM 104 calls the appropriate method on FMM 106 to retrieve the requested subset of data (READ DATA).

DCSM 104 packages the subset of data as XML, compresses the subset of data and creates a SOAP attachment (P-XML, CC-A). DCSM 104 returns the SOAP message with attachment (RSMA) to DCCM 102 on the web browser. DCCM 102 extracts the attachment and decompresses the XML file (EXT-A, D-XML), and loads the XML containing the subset of data to the local cache of the web browser (LOAD DB). DCCM 102 returns the XML file to the UI application 100 (RET XML), which then displays the subset of data (DD).

If the blocking parameter is not set, i.e., the call is not blocked, DCCM 102 will return (RET) to the UI application 100, and send a GD request to DCSM 104. The same process as in the blocked case is followed, but DCC will send an event to the UI application with the success or failure of the call, e.g., will raise a data changed event (RDCE). UI application 100 can then retrieve the subset of data it is interested in by calling the Get Data method on DCCM 102 to retrieve the requested subset of data from the local cache.

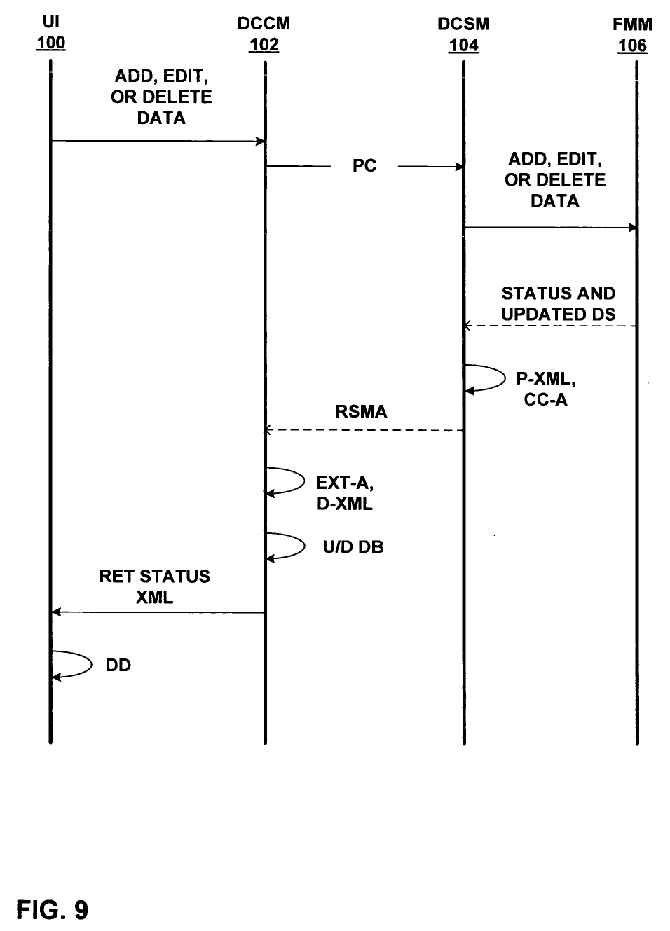

FIG. 9 is a message flow diagram illustrating the process of updating a set of data in the data conduit transfer technique. The user may update a set of data of a server by adding, editing, or deleting a subset of the set of data at a web browser. The data conduit transfer technique communicates this updating of a subset of data to the central database and local cache as follows. UI application 100 calls an Add, Edit, or Delete Data method on DCCM 102 with the data that needs to be updated. The DCCM 102 will then call the Modify Data method on DCSM 102 to post the changes (PC).

DCSM will in turn call FMM 106 to update the data and get the status of the update (i.e., successful update or failed update). A failed update may occur, for example, where two users are attempting to update the same data at the same time. One user will receive a failed update, and will have to try updating again after the other user has finished their update. For an “Add,” the results may include an entity ID. DCSM 104 returns the status of the update to DCCM 102, packaged as XML, compressed, and created in an attachment (P-XML, CC-A). DCCM 102 extracts the attachment and decompresses the XML file (EXT-A, D-XML). If the results are successful, the updated data will be added to the local cache (U/D DB). Finally, DCCM 102 returns the results of the update to UI application 100, which displays the data (DD).

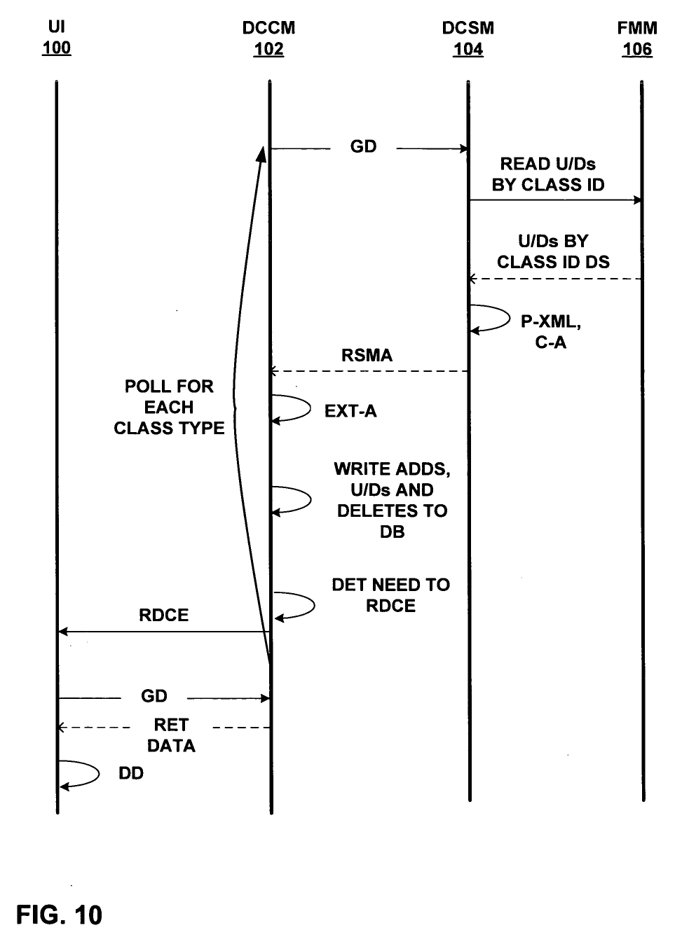

FIG. 10 is a message flow diagram illustrating the process of polling for updated data in the data conduit transfer technique. On a configurable interval, DCCM 102 will poll DCSM 104 for updates. The poll rate can be set to a different frequency for different data sets, for example, every 5 minutes for TripList data, and every 30 minutes for Trucks and Sites data. DCCM 102 will pass a last poll time indication with the poll that indicates the last time that data was retrieved, either by the initial GD call or the last poll for changes. DCCM 102 may also include a “Class ID” indicating the class of data for which it is requesting updates. DCSM 104 will then call FMM 106 to retrieve all the updates for this data set since the last retrieval.

FMM 106 looks at the last poll time indication, searches the central database for data that has been updated since the last poll time, and sends to DCSM 104 any data with a time stamp more recent than the last poll time. In this way, DCSM 104 sends only the data that has been updated since DCCM 102 last polled the server. This may result in faster updating, since instead of reloading all of the data in the central database, DCCM 102 only has to load the updated data. FMM 106 may read for updates by class ID.

FMM 106 packages the updates as an XML document and creates an attachment (P-XML, C-A) and may add an additional “action” attribute for each node in the XML. The action attribute may contain an ‘A’ for add, ‘E’ for edit, or ‘D’ for delete. Finally, DCSM 104 returns the updates as an attachment to a SOAP message (RSMA).

Upon receiving the returned soap message, DCCM 102 extracts the attachment and looks at each node to determine the action to take on the local cache. DCCM 102 will write any adds, updates, or deletes to the cache, and determine the need to raise a data changed event (DET NEED TO RDCE) for this particular class type. Once it has completed updating the local cache, if it has determined there is a need for an event, DCCM 102 will raise the event to the UI application 100 indicating there are updates to this particular data set (RDCE). This polling process takes place for each class type, e.g., TripList, Sites, and Trucks data. After notification of the data changed event, UI application 100 can then retrieve the data it is interested in by calling the Get Data method on DCCM 102 to retrieve the requested data from the local cache. After DCCM 102 returns the requested data to UI application 100 (RET DATA), UI application 100 can display the data (DD).

The process is repeated periodically according to the frequencies configured by the user. As mentioned, the polling frequency may be set by the user to poll at different time intervals for different data sets. In this manner, the data conduit transfer technique updates the data to the local cache automatically as a background task.

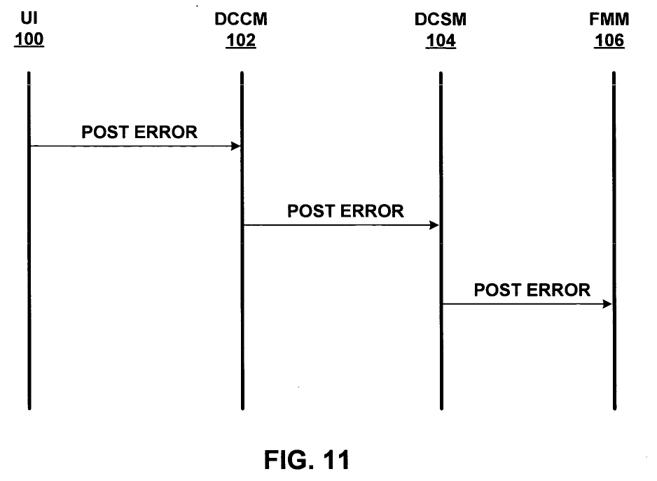

FIG. 11 is a message flow diagram illustrating the process of posting an error in the data conduit transfer technique. To post an error onto the server, UI application 100 calls a Post Error method on DCCM 102. DCCM 102 in turn calls a Post Error method on DCSM 104, which in turn calls a Post Error method on FMM 106.

Various embodiments of the invention have been described. For example, a data transfer system has been described that includes a set of web-based applications designed to rapidly transfer large amounts of data as a background task, and similarly transfer updated data without requiring a user to request the updated data. Although many details of this disclosure are outlined in the context of a fleet management system, the invention may find application in environments such as stock exchanges, commodities trading, or any other environment in which many users must access large volumes of shared data that is periodically updated by the different users.

The techniques described herein may be implemented respectively web browsers and a server computer (or possibly multiple servers). In any case, the techniques may be implemented in hardware, software, firmware, or any combination thereof on the respective computers. If implemented in software, the techniques may be directed to a computer-readable medium comprising program code, that when executed, perform one or more of the techniques described herein. For example, the computer-readable medium may store computer readable instructions that when executed in a processor cause the respective client or server to carry out one or more of the techniques described herein. In other words, the various modules described herein are not limited to a particular hardware or software configuration, but may be implemented as any combination of hardware, software, or computer processors fabricated or programmed to execute the techniques described herein. These and other embodiments are within the scope of the following claims.

1. A method comprising:
receiving a subset of data at a web browser from a server computer in response to a request from the web browser for the subset of data, the request for the subset of data being a user-initiated event initiated by a user at the web browser;
caching the subset of data at the web browser;
automatically sending a request from the web browser for updated data, the request for the updated data being a web application-initiated event initiated automatically by the web browser;
receiving the updated data at the web browser from the server; and
updating the cached subset of data at the web browser to reflect the updated data.

2. The method of claim 1, wherein receiving the updated data occurs over a default browser port.

3. The method of claim 1, wherein the request for updated data comprises a request for data that has changed since a most recent request, and wherein the request for updated data includes an indication of a time of the most recent request.

4. The method of claim 1, wherein the user makes the request for the subset of data via a user interface application of the web browser.

5. The method of claim 4, further comprising raising an event to the user interface that the subset of data has been received.

6. The method of claim 1, further comprising repeatedly sending an automatic request for updated data from the web browser on an interval, wherein the interval of the automatic request is configurable.

7. The method of claim 1, wherein the subset of data comprises fleet management data, wherein the user is a dispatcher, and wherein the web browser is used by the dispatcher in viewing the fleet management data.

8. The method of claim 1, wherein updating the cached subset of data at the web browser comprises prioritizing an order of updating the cached subset of data such that a currently active set of the subset of data on the web browser is updated prior to updating a currently inactive set of the subset of data.

9. The method of claim 1, wherein the user does not initiate the request for updated data.

10. The method of claim 1, further comprising viewing the subset of data at the web browser.

11. The method of claim 1, wherein the updated data comprises one of an addition, edit, or deletion to the subset of data.

12. A computer-readable medium comprising instructions that when executed by a web browser of a fleet management system cause the web browser to:
receive fleet management data from a server computer in response to a request from the web browser for the fleet management, the request for the fleet management being a user-initiated event initiated by a user at the web browser;
cache the fleet management data at the web browser;
automatically send a request from the web browser for updated data, the request for the updated data being a web application-initiated event initiated automatically by the web browser;
receive the updated data at the web browser from the server; and
update the cached fleet management data at the web browser to reflect the updated data.

13. A method comprising:
storing a set of data in a database;
receiving a request from a first web browser for a first subset of the set of data, the request for the first subset of the set of data being a user-initiated event initiated by a first user at the first web browser;
sending the first subset of the set of data to the first web browser;
receiving a data update from a second web browser, the data update being entered by a second user at the second web browser with respect to a second subset of the set of data;
updating the set of data in the database based on the data update received from the second web browser;
receiving a request for updated data from the first web browser, the request for the updated data being a web application-initiated event initiated automatically by the first web browser; and
sending the updated data to the first web browser in response to the request for the updated data.

14. The method of claim 13, further comprising marking the updated data in the database with a time stamp.

15. The method of claim 14, further comprising:
checking the database for data having a time stamp more recent than a most recent request of the first web browser, a time of the most recent request being indicated in the request for updated data,
wherein sending the updated data comprises sending data having a time stamp more recent than the time of the most recent request.

16. The method of claim 13, further comprising compressing the first subset of the set of data prior to sending the first subset of the set of data.

17. The method of claim 13, further comprising sending the first subset of the set of data and the updated data as attachments to Extensible Markup Language (XML)-based Simplified Object Access Protocol (SOAP) messages.

18. The method of claim 13, wherein the set of data comprises fleet management data, wherein the first and second users are dispatchers, and wherein the web browsers are used by the dispatchers in viewing subsets of the fleet management data.

19. The method of claim 13, wherein the data update comprises one of an addition, edit, or deletion to the second subset of the set of data.

20. A computer-readable medium comprising instructions that when executed by a server computer of a fleet management system cause the server computer to:
store a set of fleet management data in a database;
receive a request from a first web browser for a first subset of the set of fleet management data, the request for the first subset of the set of fleet management data being a user-initiated event initiated by a dispatcher at the first web browser;
send the first subset of the set of fleet management data to the first web browser;
receive a data update from a second web browser, the second web browser being associated with a vehicle of a fleet managed by the fleet management system;
update the set of fleet management data in the database based on the data update received from the second web browser;
receive a request for updated data from the first web browser, the request for the updated data being a web application-initiated event initiated automatically by the first web browser; and
send the updated data to the first web browser in response to the request for the updated data.

21. A device comprising:
a local cache that stores a subset of data;
a user interface application that displays at least some of the subset of data from the local cache;
a data conduit client module that:
receives the subset of data from a server computer in response to a request from the data conduit client module for the subset of data, the request for the subset of data being a user-initiated event initiated by a user at the device;
stores the subset of data to the local cache;
automatically sends a request for updated data, the request for the updated data being a web application-initiated event initiated automatically by the data conduit client module;
receives the updated data from the server; and
updates the stored subset of data in the local cache to reflect the updated data.

22. The device of claim 21, wherein the data conduit client module repeatedly sends an automatic request for updated data on an interval, wherein the interval of the automatic request is configurable.

23. The device of claim 21, wherein the subset of data stored in the local cache comprises fleet management data, wherein the user is a dispatcher, and wherein the web browsers are used by the dispatchers in viewing at least some of the fleet management data.

24. The device of claim 21, wherein the received updated data includes one of an addition, edit, or deletion to the subset of data.

25. A device comprising:
a central database that stores a set of data; and
a data conduit server module that:
receives a request from a first web browser for a first subset of the set of data, the request for the first subset of the set of data being a user-initiated event initiated by a first user at the first web browser;
sends the first subset of the set of data to the first web browser;
receives a data update to a second subset of the set of data from a second web browser, the data update being entered by a second user at the second web browser;
updates the set of data in the central database based on the data update received from the second web browser;
receives a request for updated data from the first web browser, the request for the updated data being a web application-initiated event initiated automatically by the first web browser; and
sends the updated data to the first web browser in response to the second request.

26. The device of claim 25, wherein the data conduit server module further marks the updated data with a time stamp.

27. The device of claim 25, wherein the set of data comprises fleet management data, wherein the first and second users are dispatchers, and wherein the web browsers are used by the dispatchers in viewing at least some of the fleet management data.

28. The device of claim 25, wherein the data update comprises one of an addition, edit, or deletion of another subset of the set of data.

29. A system comprising:
a server that stores and updates a set of data;
a plurality of web browsers that each:
send data updates to the server to update the set of data;
automatically send requests to the server for updates to a subset of the set of data, wherein the automatic requests for updates are web application-initiated events sent by the web browsers;
receive data updates from the server in response to the web application-initiated events; and
store the data updates to a local cache that contains the subset of the set of data.

30. The system of claim 29, wherein the data updates are one of additions, edits, or deletions to the subset of the set of data in the local cache.
